(19) United States
(12) Patent Application Publication
(10) Pub. No.: US 2005/0285786 A1
(43) Pub. Date: Dec. 29, 2005

(54) Multi-antenna system and related component and method

(75) Inventor: Nader Fayyaz, Kitchener (CA)

Correspondence Address: Gowling Lafleur Henderson, 2600-160 Elgin Street, Ottawa, ON, K1P 1C3, CA

(73) Assignee: RFTune Inc.

(21) Appl. No.: 11/165,501

(22) Filed: Jun. 24, 2005

(30) Foreign Application Priority Data
Jun. 25, 2004 (CA) 2,472,417

(51) Int. Cl. H01Q 3/22

(52) U.S. Cl. 342/372

(57) ABSTRACT

A multi-antenna system and related component and method is provided. The antenna system includes a receiver section, a transmitter section and a controller. Each of the receiver and transmitter sections contains a phase shifter. The controller outputs the phase shift signal. The system may employ algorithm for beam forming. The phase shift value of the phase shifter is changed. The phase and gain of the receiver section in receiver mode is applied to the transmitter section in transmitter mode.

### FIELD OF THE INVENTION

The present invention relates to a signal processing, more particularly to a multi-antenna system and related component and method.

### BACKGROUND OF THE INVENTION

Wireless local area networks (WLANs) are well known in the art. FIG. 1 shows a conventional wireless local area network (WLAN) system 1. The WLAN system 1 includes one access point AP and wireless nodes #1-#3. In the system 1, an electromagnetic signal on air (EM) changes slowly (5-10 seconds). The conventional system 1 has problems, such as Dead-spots, Range, Power consumption, Interference.

In recent years, there have been substantial improvements in wireless communication systems. One of the key technologies in such improvements is a smart antenna. The smart antenna system has receiving and transmitting antenna sections and a signal processor for enhancing the performance of the system, such as transmission and reception performances, beam forming. In current smart antenna systems, a phase shifter is one of the main components, and is one of the limiting factors for reducing the size and required cost of the smart antenna systems.

Hence it is desirable to provide a new system and method that can provide wireless communication services with high signal quality.

### SUMMARY OF THE INVENTION

It is an object of the invention to provide a novel smart antenna system and a method that obviate or mitigate at least one of the disadvantages of existing systems.

In accordance with an aspect of the present invention, there is provided a system for a signal processing associated with a plurality of antennas which includes: a controller for providing phase shift signals; and a receiver section having a plurality of mixers and current sources. Each of the mixers is provided for mixing an input signal from the corresponding antenna with the corresponding phase shift signal. Each of the current sources is provided for being applied to the corresponding mixer. The phase shift signal and the current source control phase and gain of a signal received at the corresponding antenna.

In accordance with a further aspect of the present invention, there is provided a system for a signal processing associated with a plurality of antennas, which includes; a controller for providing phase shift signals; and a transmitter section having a plurality of mixers and current sources. Each of the mixers is provided for mixing an IF signal with the corresponding phase shift signal to provide a signal to the corresponding antenna section. Each of the current sources is provided for being applied to the corresponding mixer. The phase shift signal and the current source control phase and gain of a signal output from the corresponding antenna.

In accordance with a further aspect of the present invention, there is provided a system for a signal processing associated with a plurality of antennas, which includes: a controller for providing phase shift signals which correspond to the antennas; a receiver section having a plurality of mixers and current sources; and a transmitter section having a plurality of mixers and current sources. Each of the mixers in the receiver section is provided for mixing an input signal from the corresponding antenna with the corresponding phase shift signal. Each of the current sources in the receiver section is provided for being applied to the corresponding mixer. Each of the mixers in the transmitter section is provided for mixing an IF signal with the corresponding phase shift signal to provide a signal to the corresponding antenna section. Each of the current sources in the transmitter section is provided for being applied to the corresponding mixer. The phase shift signal and the current source control the phase and gain of a signal from or to the corresponding antenna.

In accordance with a further aspect of the present invention, there is provided a system for a signal processing associated with a plurality of antennas. The antennas includes: first and second antennas, the phase difference between the first and second antenna being θ. The system includes: a first path for a first antenna, which has a variable phase shifter for phase shifting a signal received on the first antenna, and a variable gain amplifier; a second path for a second antenna which has a variable gain amplifier; a combiner for combining the outputs of the first and second paths; and a controller for changing a phase shift value φ of the variable phase shifter at each packet within a certain period to find a maximum θ.

In accordance with a further aspect of the present invention, there is provided a method of operating a multi-antenna system for beam forming. The method includes the step of; at a first path for a first antenna, phase shifting a signal received on the first antenna at a variable phase shifter and gain adjusting the output of the variable phase shifter; at a second path for a second antenna, gain adjusting a signal received on the second antenna, the phase difference between the first and second antenna being θ; combining the outputs of the first and second paths, and changing a phase shift value φ of the variable phase shifter at each packet within a certain period to find a maximum θ.

In accordance with a further aspect of the present invention, there is provided a circuit for phase shifting. The circuit includes a variable phase shifter which has a sine component for receiving an input signal; a cosine component for receiving the input signal; a first active device receiving a phase control signal; second active devices connected to the first active device and activated by the outputs of the sine and cosine components, and a node for combining the outputs of the second active devices. The phase control signal controls bias of the first active device and ratio of combination of the outputs from the sine and cosine components.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a diagram showing a conventional WLAN system;

FIG. 2 is a diagram showing a smart antenna system (RF transceiver) in accordance with a first embodiment of the present invention;

FIG. 3 is a diagram showing one example of the smart antenna RF transceiver of FIG. 2;

FIG. 4 is a diagram showing another example of the smart antenna RF transceiver of FIG. 2;

FIG. 5 is a schematic diagram showing one example of the receiver section of FIGS. 3 and 4;

FIG. 6 is a schematic diagram showing one example of the transmitter section of FIGS. 3 and 4;

FIGS. 7A and 7B are schematic diagrams showing a quadrature receiver section for a quadrature smart antenna transceiver to which the receiver section of FIG. 5 is applied;

FIGS. 8A and 8B are schematic diagrams showing a quadrature transmitter section for a quadrature smart antenna transceiver to which the transmitter section of FIG. 6 is applied;

FIG. 9 is a schematic diagram showing a variable phase shifter in accordance with a first embodiment of the present invention;

FIG. 10 is a diagram showing an application of the phase shifter of FIG. 9;

FIG. 11 is a diagram showing another application of the phase shifter of FIG. 9;

FIG. 12 is a schematic diagram showing a frequency doubler of the phase shit circuit of FIG. 11;

FIG. 13 is a schematic diagram showing a current source of the frequency doubler of FIG. 12;

FIG. 14 is a diagram showing a smart antenna system (RF transceiver) in accordance with a second embodiment of the present invention;

FIG. 15 is a schematic diagram showing one example of a beam forming interval of FIG. 14;

FIG. 16 is a schematic diagram showing a smart antenna receiver section of FIG. 14;

FIG. 17 is a schematic diagram showing a smart antenna transmitter section of FIG. 14;

FIG. 18 is a flow chart showing one example of the operation for beam forming applied to FIG. 14;

FIG. 19 is a schematic diagram showing a first embodiment of the algorithm for beam forming applied to the system of FIG. 14;

FIG. 20 is a schematic diagram showing a second embodiment of the algorithm for beam forming applied to the system of FIG. 14; and

FIG. 21 is a schematic diagram showing a third embodiment of the algorithm for beam forming applied to the system of FIG. 14.

### DETAILED DESCRIPTION OF THE PREFERRED EMBODIMENTS

The present invention is suitably used for a multi-antenna system, e.g. a smart antenna system. The smart antenna system comprises a plurality of antennas. In a front-end, incoming signals from the antennas are processed in receiver mode, and an IF signal is provided to the antenna in transmitter mode.

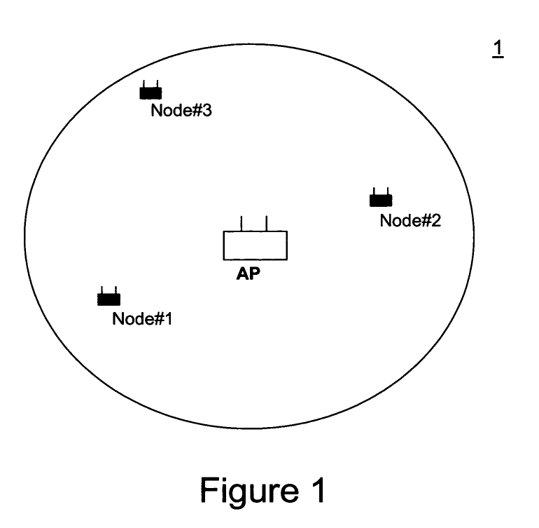

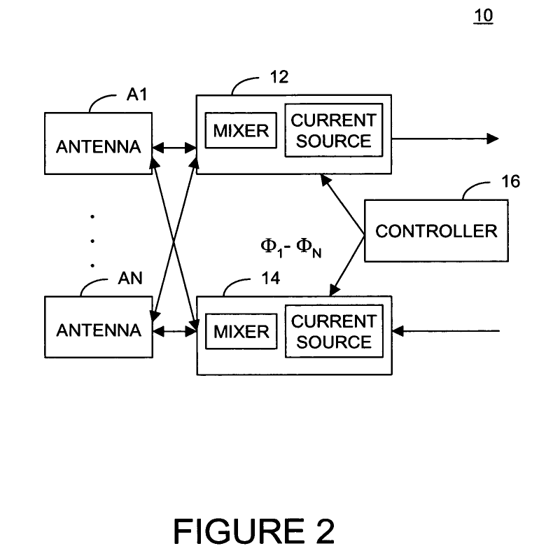

FIG. 2 shows a smart antenna system (RF transceiver) 10 in accordance with a first embodiment of the present invention. The smart antenna transceiver 10 includes a receiver section 12, a transmitter section 14 and a controller 16 for providing phase shift signals Φ₁-Φ_{N}. In FIG. 1, antennas A1-AN are shown. The transceiver 10 of FIG. 1 may be a quadrature smart antenna transceiver.

The receiver section 12 includes a plurality of mixers. Each mixer of the receiver section 12 mixes an input signal from the corresponding antenna with the corresponding phase shift signal. A current source is preferably provided to the mixer of the receiver section 12. The phase shift signal and the current source control the phase and gain of a signal received at the corresponding antenna.

The transmitter section 14 includes a plurality of mixers. Each mixer of transmitter section 14 mixes an IF signal with the corresponding phase shift signal to provide a signal to the corresponding antenna. A current source is preferably provided to the mixer of the transmitter section 14. The phase shift signal and the current source control the phase and gain of a signal output from the corresponding antenna.

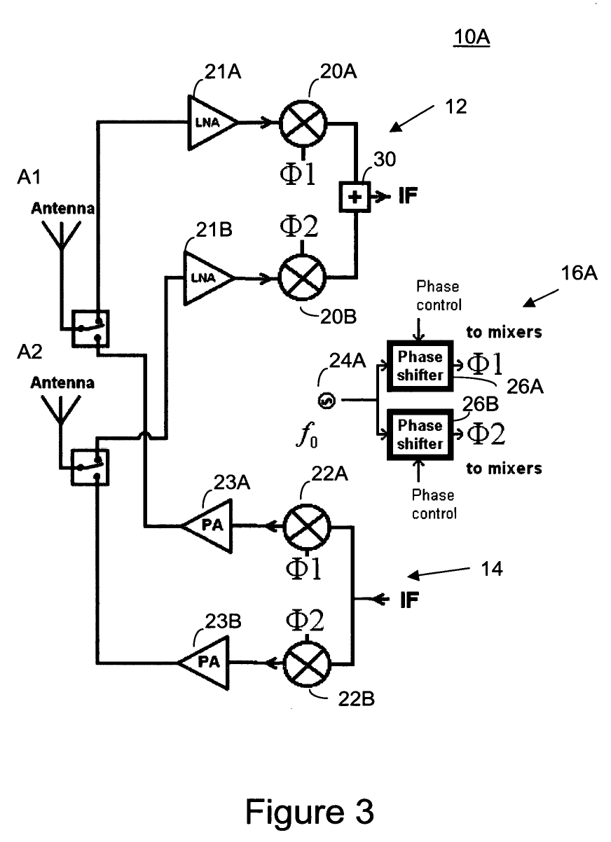

FIG. 3 shows one example of the smart antenna RF transceiver of FIG. 2. The transceiver 10A of FIG. 3 includes the receiver section 12, the transmitter section 14, and a controller 16A which provides the phase shift signals Φ₁ and Φ₂. In FIG. 2, two antennas A1-A2 are shown.

The receiver section 12 contains mixers 20A and 20B, and Low Noise Amplifiers (LNAs) 21A and 21B. A signal from the antenna A1 is provided to the mixer 20A via the LNA 21A. A signal from the antenna A2 is provided to the mixer 20B via the LNA 21B. The phase shift signals Φ₁ and Φ₂ are provided to the mixers 20A and 20B, respectively. The outputs from the mixers 20A and 20B are combined at a combiner 30, which outputs an IF signal.

The transmitter section 14 contains mixers 22A and 22B, and power amplifiers (PAs) 23A and 23B. An IF signal is provided to the mixers 22A and 22B. The phase shift signals Φ₁ and Φ₂ are provided to the mixers 22A and 22B, respectively. The outputs from the PAs 23A and 23B are provided to the antennas A1 and A2, respectively.

The controller 16A has an oscillator 24A for outputting a signal with frequency f₀, and two phase shifters 26A and 26B, which output the phase shift signals Φ₁ and Φ₂. The phase shifter receives the output of the oscillator 24A and performs phase-shifting in response to a phase control signal.

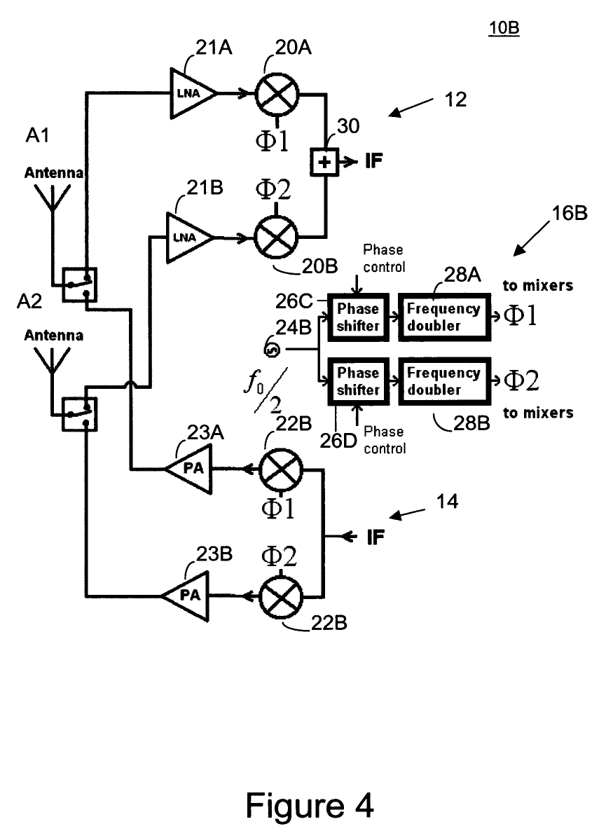

FIG. 4 shows another example of the smart antenna RF transceiver of FIG. 2. The transceiver 10B of FIG. 4 includes the receiver section 12, the transmitter section 14 and the controller 16B.

The controller 16B has an oscillator 24B for outputting a signal with frequency f₀/2, and the phase shifters 26C and 26D. The phase shifter receives the output of the oscillator 24B and performs phase-shifting in response to a phase control signal. For increasing phase range of the oscillator 24B, frequency doublers 28A and 28B are provided to the phase shifters 26C and 26D, respectively. The frequency doublers 28A and 28B output the phase shift signals Φ₁ and Φ₂.

In FIGS. 3 and 4, two antennas are shown. However, for higher gain, more than two antennas can be provided. For N antennas (N is integer), the transceiver (10A, 10B) has N Low Noise Amplifiers (LNAs), N Power Amplifiers (PAs) and 2×N mixers.

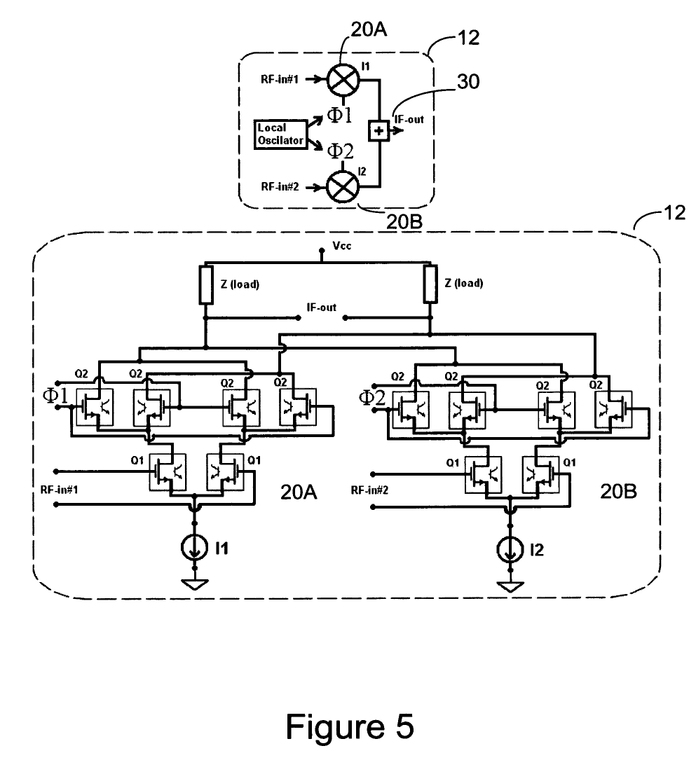

FIG. 5 shows one example of the receiver section 12 of FIGS. 3 and 4. In FIG. 5, “RF-in#1” represents a signal from the antenna A1; “RE-in#2” represents a signal from the antenna A2; and “IF-out” represents an IF signal output from the receiver section 12.

Each of the mixers 20A and 20B of FIG. 5 contains active devices Q1 and Q2. Current sources I1 and I2 are provided to the active devices Q1 of the mixers 20A and 20B. The active device Q1 of the mixer 20A is activated by the signal RF-in#1. The active device Q2 of the mixer 20A is activated by the phase shift signal Φ₁. The active device Q1 of the mixer 20B is activated by the signal RF-in#2. The active device Q2 of the mixer 20B is activated by the phase shift signal Φ₂.

The phase shift signal Φ₁ and the current source I1 control the phase and gain of a signal provided from one of the antennas. The phase shift signal Φ₂ and the current source I2 control the phase and gain of a signal provided from the other antennas. These phase/gain controls improve a signal to noise or a signal to interference ratio.

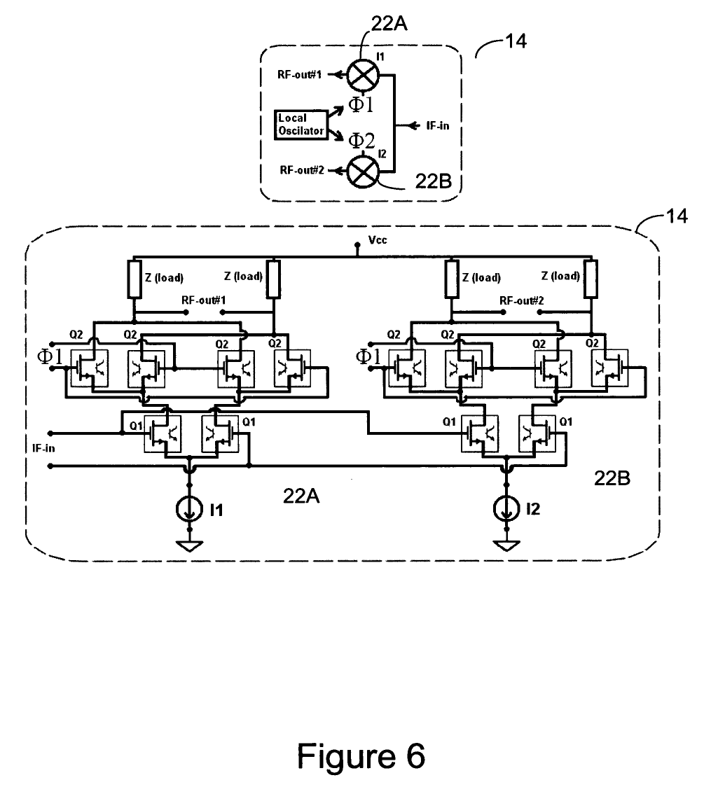

FIG. 6 shows one example of the transmitter section 14 of FIGS. 3 and 4. In FIG. 6, “RF-out#1” represents a signal provided to the antenna A1; “RE-out#2” represents a signal provided to the antenna A2; and “IF-in” represents an IF signal provided to the transmitter section 14.

Each of the mixers 22A and 22B of FIG. 6 contains active devices Q1 and Q2. Current sources I1 and I2 are provided to the active devices Q1 of the mixers 22A and 22B. The active device Q1 of the mixer 22A is activated by the IF signal IF-in. The active device Q2 of the mixer 22A is activated by the phase shift signal Φ₁. The active device Q1 of the mixer 22B is activated by the IF signal IF-in. The active device Q2 of the mixer 22B is activated by the phase shift signal Φ₂.

The phase shift signal Φ₁ and the current source I1 control the phase and gain of a signal provided to one of the antennas. The phase shift signal Φ₂ and the current source I2 control the phase and gain of a signal provided to the other antenna. These phase/gain controls improve an RF radiation pattern.

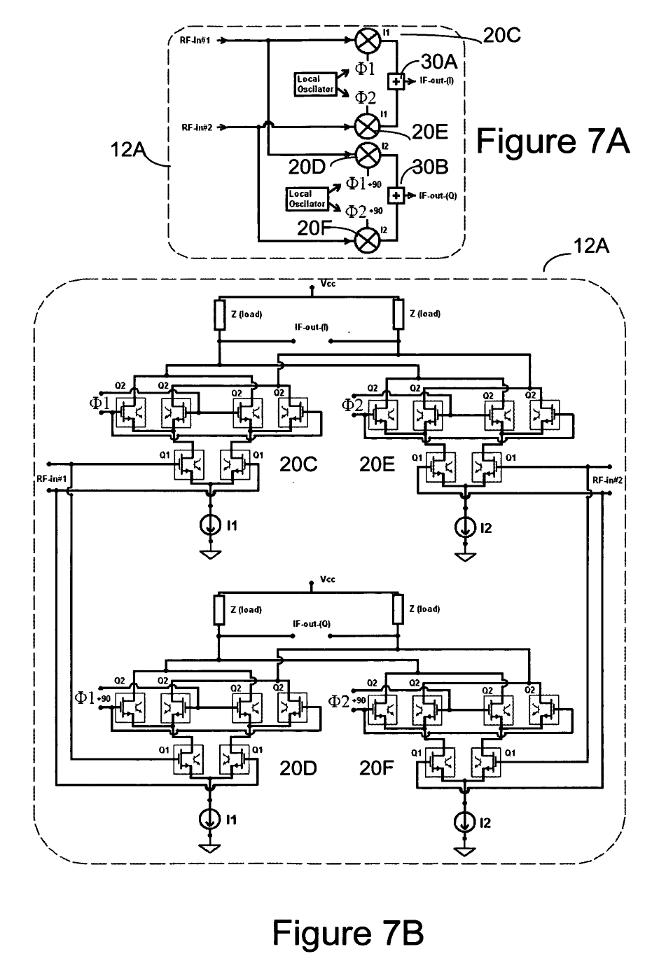

The concept of the receiver section 12 is applicable to a receiver for a quadrature smart antenna transceiver. FIGS. 7A and 7B show a quadrature receiver section 12A for a quadrature smart antenna transceiver that has two antennas. In FIGS. 7A and 7B, “RF-in#1” represents a signal from the antenna A1; “RE-in#2” represents a signal from the antenna A2; “IF-out-(I)” represents an I (in-phase) component of an IF signal output from the receiver section 12A; “IF-out-(Q)” represents a Q (quadrature phase) component of the IF signal output from the receiver section 12A.

The quadrature receiver section 12A contains mixers 20C and 20D for the antenna A1, and mixers 20E and 20F for the antenna A2. The mixers 20C and 20D are similar to the mixer 20A. The mixers 20E and 20F are similar to the mixer 20B.

The phase shift signals Φ₁ and (Φ₁+90) are provided to the mixers 20C and 20D, respectively. The phase shift signals Φ₂ and (Φ₂+90) are provided to the mixers 20E and 20F, respectively. A combiner 30A combines the outputs from the mixers 20C and 20E, and outputs an IF signal IF-out-(I). A combiner 30B combines the outputs from the mixers 20D and 20F, and outputs an IF signal IF-out-(Q).

The phase shift signal Φ₁ and the current source I1 control the phase and gain of a signal provided from one of the antennas. The phase shift signal Φ₂ and the current source I2 control phase and gain of a signal provided from the other antennas. These phase/gain controls improve a signal to noise or a signal to interference ratio.

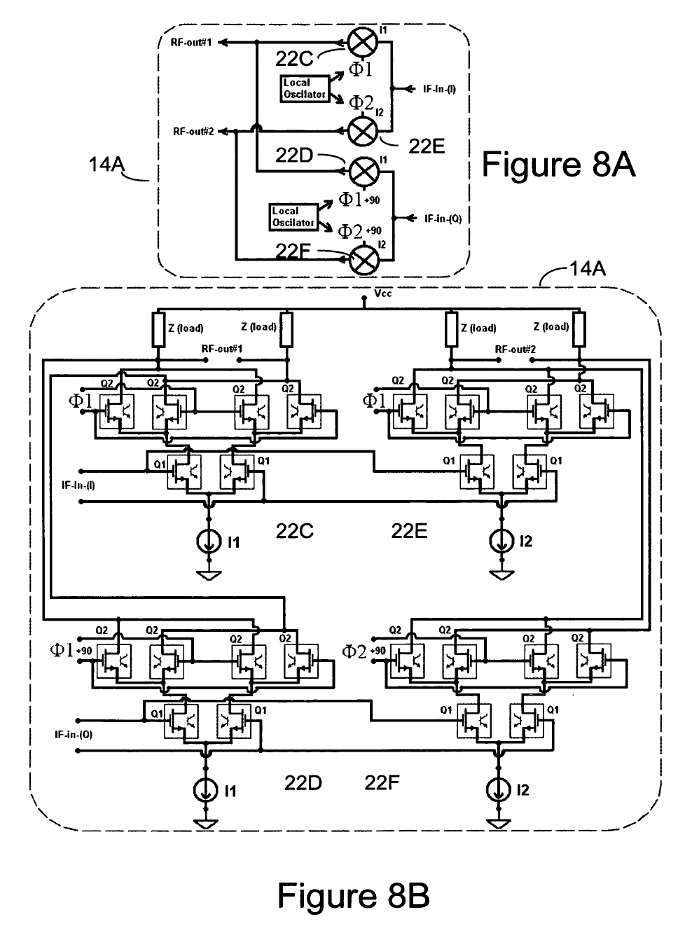

The concept of the transmitter section 14 is applicable to a transmitter for a quadrature smart antenna transceiver. FIGS. 8A and 8B show a quadrature transmitter section 14A for a quadrature smart antenna transceiver that has two antennas. In FIGS. 8A and 8B, “RF-out#1” represents a signal provided to the antenna A1; “RE-out#2” represents a signal provided to the antenna A2; “IF-in-(I)” represents an I (in-phase) component of an IF signal provided to the transmitter section 14A; “IF-in-(Q)” represents a Q (quadrature) component of the IF signal provided to the transmitter section 14A.

The quadrature transmitter section 14A contains mixers 22C and 22D for the antenna A1, and mixers 22E and 22F for the antenna A2. The mixers 22C and 22D are similar to the mixer 22A. The mixers 22E and 22F are similar to the mixer 22B.

The phase shift signals Φ₁ and (Φ₁+90) are provided to the mixers 22C and 22D, respectively. The phase shift signals Φ₂ and (Φ₂+90) are provided to the mixers 22E and 22F, respectively. The output from each of the mixer 22C and 22D are provided to the antenna A1. The output from each of the mixer 22E and 22F are provided to the antenna A2.

The phase shift signal Φ₁ and the current source I1 control the phase and gain of a signal provided to one of the antennas. The phase shift signal Φ₂ and the current source I2 control the phase and gain of a signal provided to the other antenna. These phase/gain controls improve an RF radiation pattern.

In the above description, the quadrature smart antenna receiver has two antennas. However, the quadrature smart antenna transceiver may have more than two antennas. The receiver section 12A may have more than two mixers and two current sources, and the transmitter section 14A may have more than two mixers and two current sources.

A phase shifter, which is preferably applicable to a smart antenna system, is now described in detail.

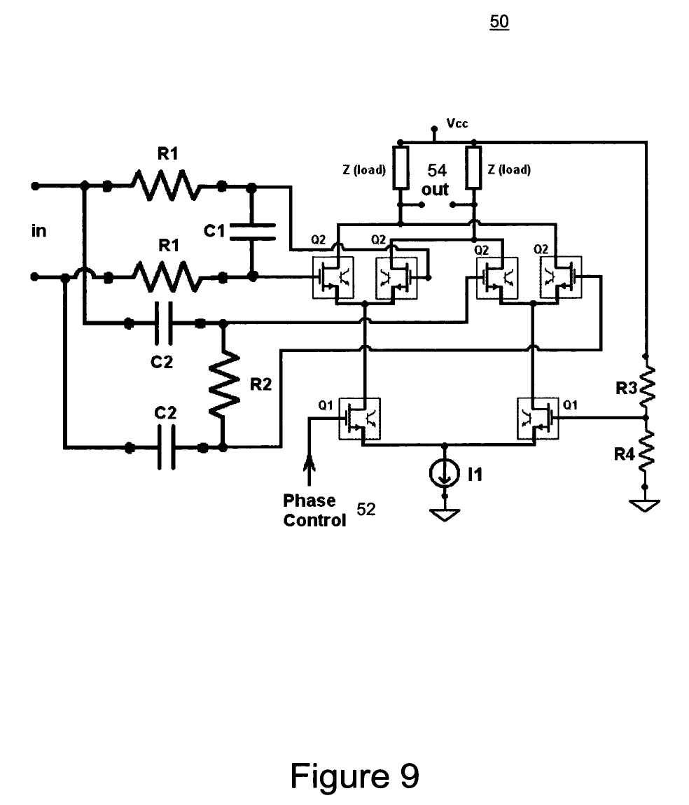

FIG. 9 shows a variable phase shifter 50 in accordance with a first embodiment of the present invention. The variable phase shifter 50 includes a sine component having C1, and a cosine component having R2. The variable phase shifter 50 further includes active devices Q1 and Q2. One of the active devices Q1 receives a phase control signal 52. The active devices Q2 receive the outputs of the sine and cosine components.

The variable phase shifter 50 has functionality as follows:

$${A}_{1} Sin ( ω t ) + {A}_{2} Cos ( ω t ) = \sqrt{{A}_{1}^{2} + {A}_{2}^{2}} \times Sin ( ω t + {tan}^{- 1} ( \frac{{A}_{2}}{{A}_{1}} ) ) \qquad ( 1 )$$

where Sin(ωt) represents a signal on C1, and Cos(ωt) represents a signal on R1.

The phase control voltage 52 controls bias of two bottom active devices (Q1, Q1) and ratio of combined Sin(ωt) and Cos(ωt).

The output signal 54 of the variable phase shifter 50 may be applied to a mixer at a smart antenna receiver section and/or a mixer at a smart antenna transmitter section for controlling the phase of receiving and/or transmitting signal. Preferably, the variable phase shifter 50 is applicable to the controllers 16A and 16B of FIGS. 3 and 4.

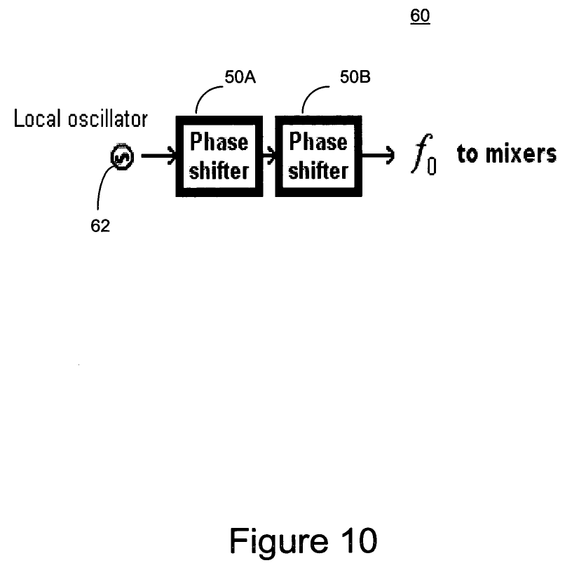

The variable phase shifter 50 may be connected in series. FIG. 10 shows an application of the variable phase shifter 50 of FIG. 9. A phase shift circuit 60 of FIG. 10 has variable phase shifters 50A and 50B, which are connected in series. The variable phase shifters 50A and 50B are similar to the variable phase shifter 50 of FIG. 9. The phase shifter 50A receives the output of a local oscillator 62, and performs phase-shifting. The phase shifter 50B receives the output of the phase shifter 50A and outputs a signal with frequency f₀.

The output of the phase shifter 50B is, for example, applied to mixers at a smart antenna transceiver, such as 20A-20F, 22A-22F, for controlling the phase of a receiving signal and/or a transmitting signal. The phase shift circuit 60 can increase phase range by using more than one phase shifter.

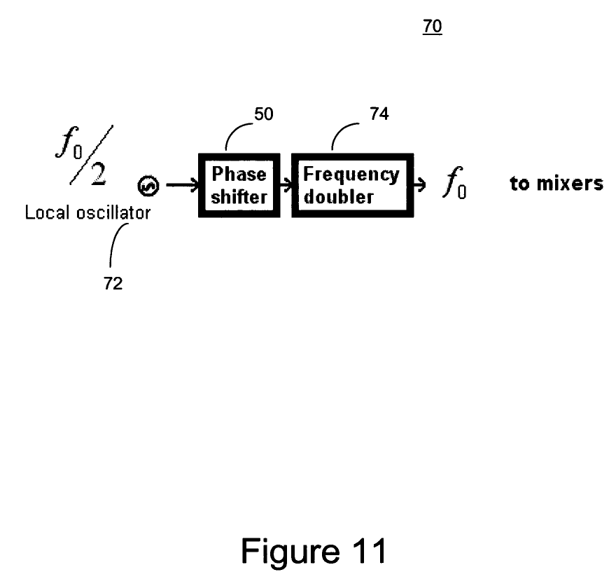

FIG. 11 shows another application of the variable phase shifter 50 of FIG. 9. A phase shift circuit 70 of FIG. 11 has the variable phase shifter 50 that receives the output (f₀/2) of a local oscillator 72 and performs phase-shifting, and a frequency doubler 74 for doubling phase range of the variable phase shifter 50. When phase range after the variable phase shifter 50 is ΔΦ, phase range after the frequency doubler 74 meets 2×ΔΦ.

The output (f₀) of the frequency doubler 74 is, for example, applied to mixers at a smart antenna transceiver for controlling the phase of a receiving signal and/or a transmitting signal.

Preferably, the phase shift circuit 70 is applicable to the controller 16B of FIG. 4. In this case, the phase shifter 50 corresponds to each of the phase shifters 26C and 26D; and the frequency doubler 74 corresponds to each of the doublers 28A and 28B.

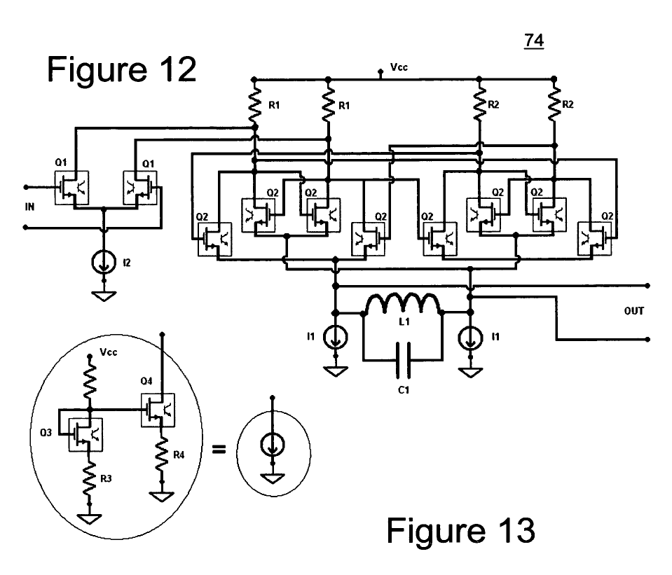

FIG. 12 shows one example of the frequency doubler 74. The frequency doubler 74 of FIG. 12 includes a bandpass filter having L1 and C1, which is tuned at double of input frequency, and current sources 11 and 12. FIG. 13 shows one example of the current source of FIG. 12.

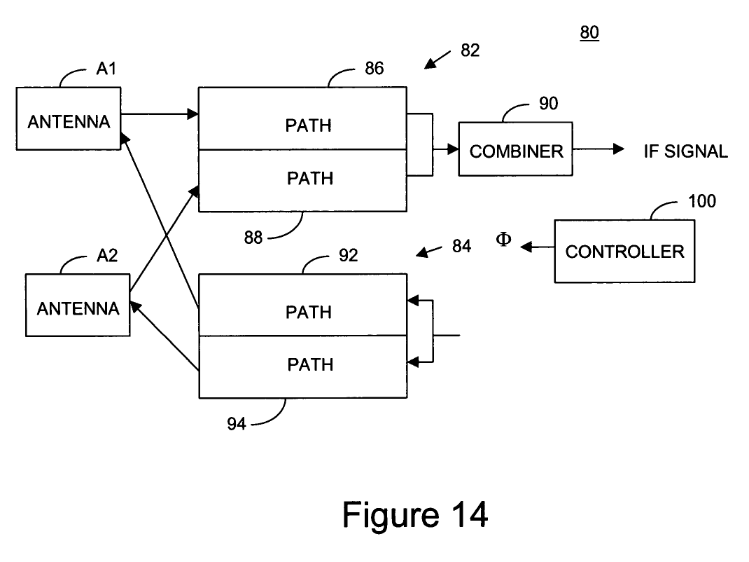

A smart antenna system in accordance with a second embodiment of the present invention is described. FIG. 14 is a diagram showing a smart antenna system (RF transceiver) 80 in accordance with the second embodiment of the present invention.

The smart antenna system 80 contains a receiver section 82 and a transmitter section 84. The receiver section 82 includes a first path 86 for the antenna A1 and a second path 88 for the antenna A2. One of the paths 86 and 88 includes a variable phase shifter as described below. A combiner 90 combines the outputs of the first and second paths 86 and 88.

The transmitter 84 contains a third path 92 for the antenna A1 and a forth path 94 for the antenna A2. Preferably, one of the paths 92 and 94 includes a variable phase shifter as described below, and the phase of the variable phase shifter in the receiver section 82 is applied to that of the transmitter section 84.

The smart antenna system 80 contains a controller 100, which employs algorithm for beam forming and changes a phase shift value Φ of the variable phase shifter at each packet within a certain period to find the maximum of θ. “θ” represents the phase difference between the first and second antennas. The algorithm is independent of protocols, such as 802.11a/b/g, BT etc.

Preferably, the smart antenna system 80 is provided at a wireless node, such as Home and/or Small Office/Home Office (SOHO).

Preferably, the controller 100 disenables the algorithm when there are two or more access point APs. When the algorithm is disenabled, the smart antenna system 80 acts as a conventional WLAN. For example, the controller 100 observes a receiver signal strength indication (RSSI). Inconsistent RSSI is an indicator for multi APs.

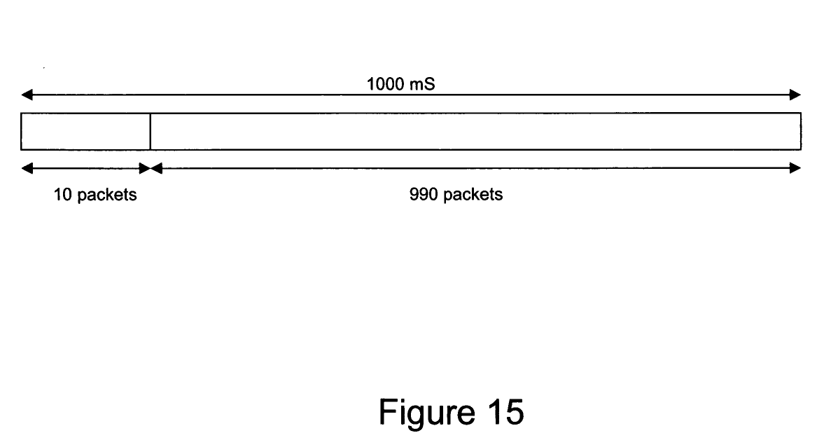

FIG. 15 is a schematic diagram showing a beam forming interval of the algorithm applied to the smart antenna system 80. As shown in FIG. 15, a beam forming interval is 1 second (slow algorithm). Among 1000 packets within 1 second, packets are used for beam forming. This results in less than 1% packet loss.

For faster beam forming, a beam forming interval shorter than 1 second may be used. For more accurate beam forming or higher antennas, more than 10 packets may be used for beam forming.

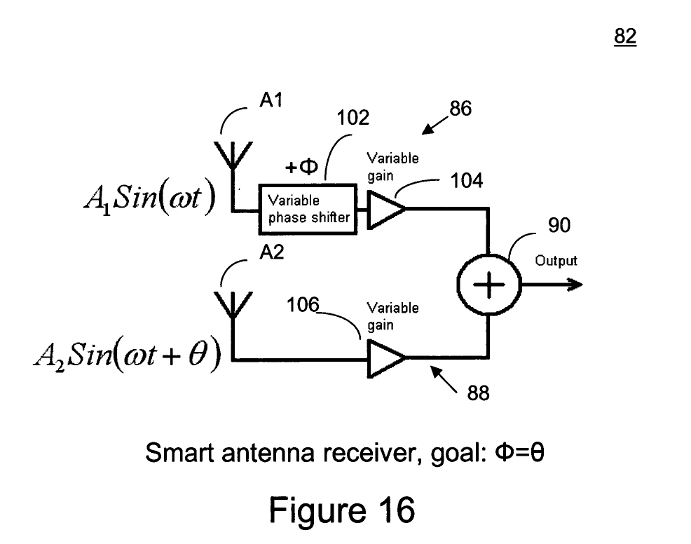

FIG. 16 shows one example of the smart antenna receiver section 82 of FIG. 14. “A₁ Sin(ω)” represents a signal on the antenna path 86. “A₂ Sin(ωt+θ)” represents a signal on the antenna path 88.

The path 86 has a variable phase shifter 102 that receives a signal from the antenna A1, and a variable gain amplifier 104 that receives the output of the variable phase shifter 86. The path 88 has a variable gain amplifier 106 that receives a signal from the antenna A2. The outputs of the paths 84 and 86 are combined by a combiner 90. The variable phase shifter 102 may be similar to the variable phase shifter 50 of FIG. 9.

The controller 100 of FIG. 14 changes a phase shift value φ at the variable phase shifter 102. The phase shift value φ at the variable phase shifter 102 is changed so as to be equal to θ.

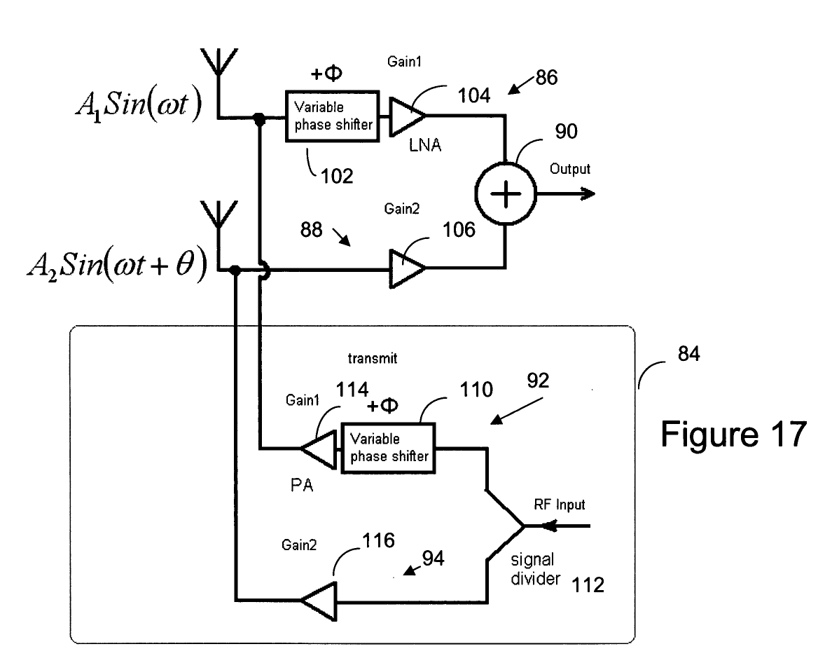

FIG. 17 shows one example of the smart antenna transmitter section 84 of FIG. 14. The path 92 has a variable gain amplifier 110 that receives a signal from a signal divider 112, and a power amplifier (PA) 114. The path 94 has a PA 116. The outputs of the paths 92 and 94 are provided to the antennas A1 and A2, respectively. The variable phase shifter 110 may be similar to the variable phase shifter 50 of FIG. 9.

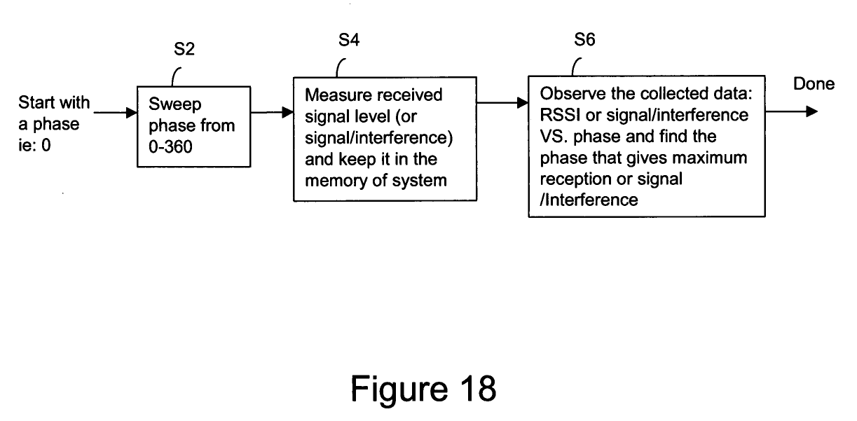

FIG. 18 is a flow chart showing one example of the operation for beam forming applied to the system of FIG. 14. At step S2, a phase φ is shifted from 0 to 360 degrees. At step S4, the level of a received signal is measured and is stored in a memory (not shown). A signal /interference may be measured, and is stored in the memory. At step S6, Received Signal Strength Indicator (RRSI) or the signal/interference is observed in view of the phase.

The phase that provides maximum reception or signal/interference is found. Phase and gain of each antenna path 86, 88 of FIGS. 14, 16 and 17 is set in receive mode for maximum performance. Same phase and gain can be applied to the transmitter 84 in transmit mode.

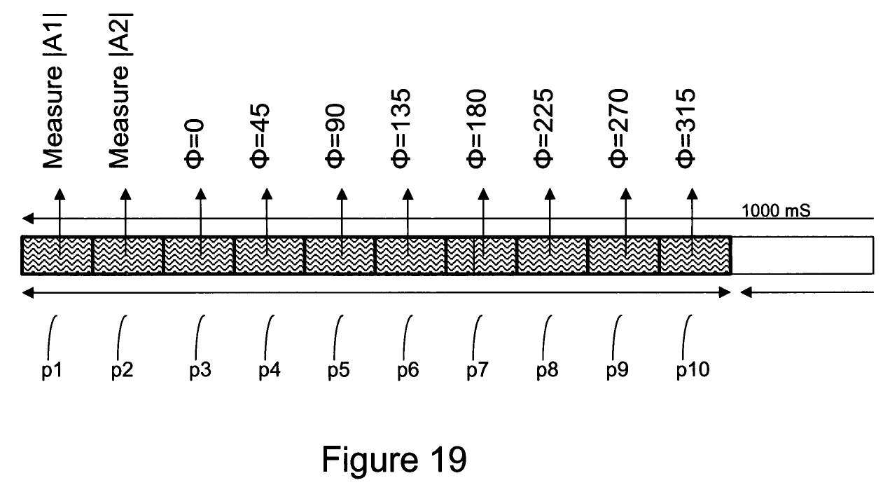

FIG. 19 shows a first algorithm for beam forming applied to the smart antenna receiver section 82 of FIG. 14. The first algorithm of FIG. 19 uses K packets (0<K #10) for beam forming. Thus, the first algorithm employs 10 tries to the maximum.

Using the first packet p1, the absolute value of A₁ is measured. Using the second packet p2, the absolute value of A₂ is measured. At the subsequent packets p3-p10, φ is set to 0, 45, 90, 135, 180, 225, 270 and 315, respectively.

At packet p4-p10, the system continuously increases phase by 45 steps (degrees) and measures/observes received signal level to find optimum phase that gives maximum reception (i.e., maximizing wanted received signal), or minimum interference (i.e., minimizing unwanted interference). Once maximum value (θ) is found by observing (measuring received signal level of smart antenna receiver), the beam forming will be stopped.

Since the phase φ is changed by 45 degrees, the phase error can be less than 45° (45° error→1.37 dB loss).

Adaptive phase step (Smarter algorithm) may be applied to the first algorithm. In FIG. 19, fixed phase steps (45 degrees) are used. However, the smarter algorithm changes this step by looking behavior of the system during the process of the algorithm. The smarter algorithm has a complex decision making capability to decide and change phase steps during the process of finding optimum phase.

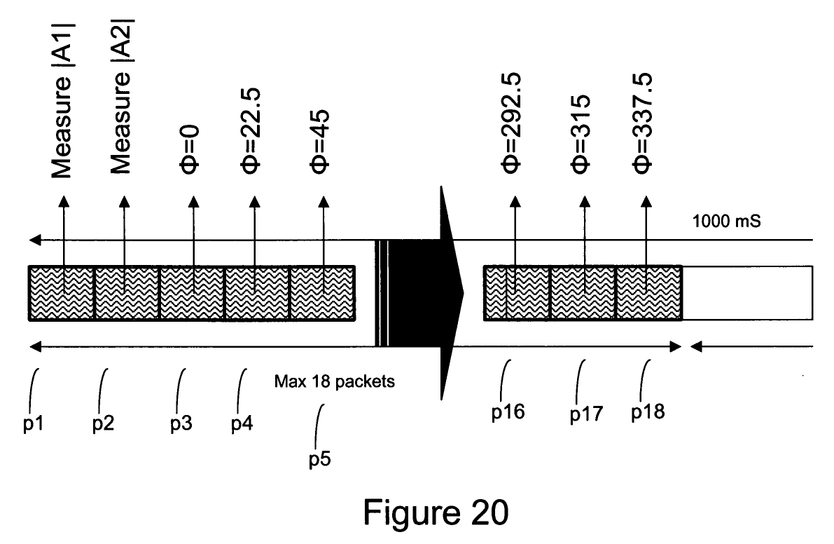

FIG. 20 shows a second algorithm for beam forming applied to the smart antenna receiver section 82 of FIG. 14. The algorithm of FIG. 20 uses 18 packets at the maximum for beam forming.

Using the first packet p1, the absolute value of A1 is measured. Using the second packet p2, the absolute value of A₂ is measured. At the subsequent packets, φ is alternatively set to 0, 22.5, 45, . . . , 292.5, 315, and 337.5. As described above, once the maximum value (θ) is found, beam forming will be stopped.

Since the phase φ is changed by 22.5 degrees, the phase error can be less than 22.5° (22.5° error→0.33 dB loss).

As describe above, adaptive phase step (Smarter algorithm) may be applied to the second algorithm.

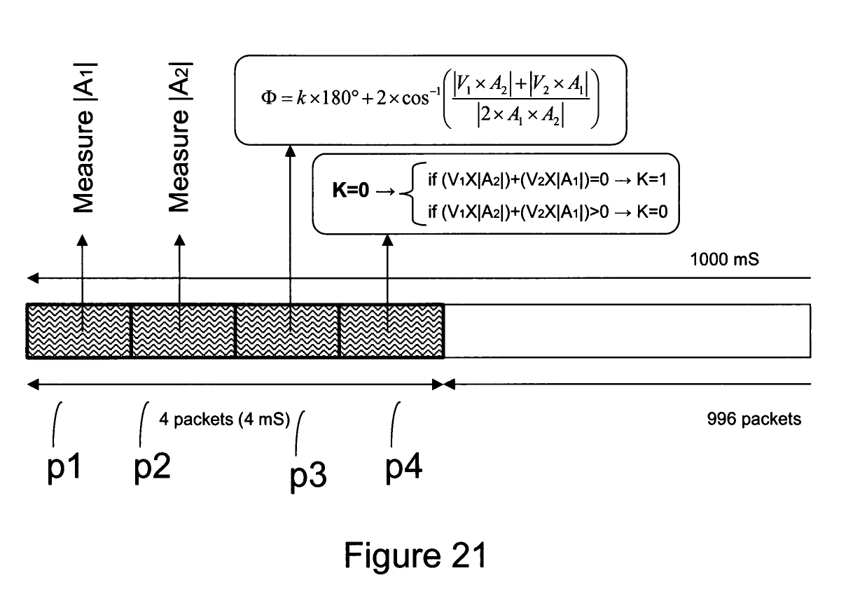

FIG. 21 shows a third algorithm for beam forming applied to the smart antenna receiver section 82 of FIG. 14. In FIG. 21, V₁=A₁ Sin(ωt) represents a signal on the path 86 of FIG. 14, and V₂=A₂Sin(ωt+θ) represents a signal on the path 88 of the FIG. 14.

Using the first packet p1, the absolute value of A₁ is measured. Using the second packet p2, the absolute value of A₂ is measured. At the third packet p3, φ is set in accordance with the following equation:

$$Φ = k \times 180 ° + 2 \times {cos}^{- 1} ( \frac{\vert {V}_{1} \times {A}_{2} \vert + \vert {V}_{2} \times {A}_{1} \vert}{\vert 2 \times {A}_{1} \times {A}_{2} \vert} ) \qquad ( 2 )$$

At the fourth packet p4, K (K: integer) is set to 1 or 0 in accordance with the following equations:
if (V₁X|A₂|)+(V₂X|A₁|)=0→K=1 (3)
if (V₁X|A₂|)+(V₂X|A₁|)>0→K=0 (4)

The third algorithm of FIG. 21 is faster than that of the first and second algorithms of FIGS. 19-20. On the other hand, the first and second algorithms of FIGS. 19-20 are robust. The controller 100 of FIG. 14 may use the first, second and third algorithms depending on an application.

While particular embodiments of the present invention have been shown and described, changes and modifications may be made to such embodiments without departing from the true scope of the invention.

1. A system for a signal processing associated with a plurality of antennas comprising:
a controller for providing phase shift signals; and
a receiver section having a plurality of mixers and current sources, each of the mixers for mixing an input signal from the corresponding antenna with the corresponding phase shift signal, each of the current sources for being applied to the corresponding mixer,
whereby the phase shift signal and the current source control phase and gain of a signal received at the corresponding antenna.

2. The system according to claim 1, wherein the controller includes an oscillator and a plurality of phase shifters, each of which phase shifts the output of the oscillator in response to a phase control signal.

3. The system according to claim 2, wherein the controller further includes a plurality of frequency doubles which correspond to the phase shifters, each of which doubles the phase range of the oscillator.

4. The system according to claim 1, wherein the receiver is a quadrature receiver and the phase shift signal has a first phase shift signal and a second phase shift signal which is 90° out of the phase of the first phase shift signal.

5. A system for a signal processing associated with a plurality of antennas comprising:
a controller for providing phase shift signals; and
a transmitter section having a plurality of mixers and current sources, each of the mixers for mixing an IF signal with the correspond phase shift signal to provide a signal to the corresponding antenna section, each of the current sources for being applied to the corresponding mixer,
whereby the phase shift signal and the current source control phase and gain of a signal output from the corresponding antenna.

6. The system according to claim 5, wherein the controller includes an oscillator and a plurality of phase shifters, each of which phase-shifts the output of the oscillator in response to a phase control signal.

7. The system according to claim 6, wherein the controller further includes a plurality of frequency doubles which correspond to the phase shifters, each of which doubles the phase range of the oscillator.

8. The system according to claim 5, wherein the receiver is a quadrature receiver and the phase shift signal has a first phase shift signal and a second phase shift signal which is 90° out of the phase of the first phase shift signal.

9. A system for a signal processing associated with a plurality of antennas comprising:
a controller for providing phase shift signals which correspond to the antennas;
a receiver section having a plurality of mixers and current sources, each of the mixers for mixing an input signal from the corresponding antenna with the corresponding phase shift signal, each of the current sources for being applied to the corresponding mixer; and
a transmitter section having a plurality of mixers and current sources, each of the mixers for mixing an IF signal with the correspond phase shift signal to provide a signal to the corresponding antenna section, each of the current sources for being applied to the corresponding mixer,
whereby the phase shift signal and the current source control phase and gain of a signal from or to the corresponding antenna.

10. The system according to claim 9, wherein the controller includes an oscillator and a plurality of phase shifters, each of which phase-shifts the output of the oscillator in response to a phase control signal.

11. The system according to claim 10, wherein the controller further includes a plurality of frequency doubles which correspond to the phase shifters, each of which performs frequency doubling of the corresponding phase shift signal.

12. The system according to claim 9, wherein the receiver section is a quadrature receiver section, and the phase shift signal has a first phase shift signal and a second phase shift signal which is 90° out of the phase of the first phase shift signal.

13. A system for a signal processing associated with a plurality of antennas which have first and second antennas, the phase difference between the first and second antenna being θ, the system comprising:
a first path for a first antenna, which has a variable phase shifter for phase shifting a signal received on the first antenna, and a variable gain amplifier;
a second path for a second antenna which has a variable gain amplifier;
a combiner for combining the outputs of the first and second paths, and
a controller for changing a phase shift value φ of the variable phase shifter at each packet within a certain period to find a maximum θ.

14. The system according to claim 13, wherein the controller sets the phase shift value φ in accordance with the following equation:
$$Φ = k \times 180 ° + 2 \times {cos}^{- 1} ( \frac{\vert {V}_{1} \times {A}_{2} \vert + \vert {V}_{2} \times {A}_{1} \vert}{\vert 2 \times {A}_{1} \times {A}_{2} \vert} )$$
where V₁=A₁ Sin(ωt) represents a signal on the first path, and V₂=A₂ Sin(ωt+θ) represents a signal on the second path,
wherein the controller sets “K” at a next packet in accordance with the following equation:
if (V₁X|A₂|)+(V₂X|A₁|)=0→K=1
if (V₁X|A₂|)+(V₂X|A₁|)>0→K=0

15. The system according to claim 13 further comprising a transmitter for transmitting a signal, the transmitter has a third path having a variable phase shifter for phase shifting a signal, and a fourth path, the phase of the variable phase shifter in the firth path being applied to that of the third path.

16. A method of operating a multi-antenna system for beam forming, the method comprising the step of;
at a first path for a first antenna, phase shifting a signal received on the first antenna at a variable phase shifter and gain adjusting the output of the variable phase shifter;
at a second path for a second antenna, gain adjusting a signal received on the second antenna, the phase difference between the first and second antenna being θ;
combining the outputs of the first and second paths,
changing a phase shift value φ of the variable phase shifter at each packet within a certain period to find a maximum θ.

17. A method of claim 16, wherein the step of controlling includes the step of setting the phase shift value φ in accordance with the following equation:
$$Φ = k \times 180 ° + 2 \times {cos}^{- 1} ( \frac{\vert {V}_{1} \times {A}_{2} \vert + \vert {V}_{2} \times {A}_{1} \vert}{\vert 2 \times {A}_{1} \times {A}_{2} \vert} )$$
where V₁=A₁ Sin(ωt) represents a signal on the first path, and V₂=A₂ Sin(ωt+θ) represents a signal on the second path,
the step of controlling further includes the step of setting “K” at a next packet in accordance with the following equation:
if (V₁X|A₂|)+(V₂X|A₁|)=0→K=1
if (V₁X|A₂|)+(V₂X|A₁|)>0→K=0

18. A method of claim 16 further comprising the step of applying the phase in the variable phase shifter at the first path to a variable phase shifter at a transmitter.

19. A circuit for a phase shifting comprising:
a sine component for receiving an input signal,
a cosine component for receiving the input signal,
a first active device receiving a phase control signal,
second active devices connected to the first active device and activated by the outputs of the sine and cosine components, the phase control signal controlling bias of the first active device and ratio of combination of the outputs from the sine and cosine components, and
a node for combining the outputs of the second active devices.

20. The circuit according to claim 19, wherein the phase shifter meets the equation as follows:
$${A}_{1} Sin ( ω t ) + {A}_{2} Cos ( ω t ) = \sqrt{{A}_{1}^{2} + {A}_{2}^{2}} \times Sin ( ω t + {tan}^{- 1} ( \frac{{A}_{2}}{{A}_{1}} ) )$$
wherein Sin(ωt) represents an output of the sine component, Cos(ωt) represents an output of the cosine component, A₁ and A₂ are variables adjusted by the phase control signal.

21. The circuit according to claim 19 further comprising a frequency doubler for doubling phase range of the variable phase shifter.

22. The circuit according to claim 21 wherein the frequency doubler includes current sources and a bandpass filter provided between the current sources.
